(19) United States
(12) Patent Application Publication
(10) Pub. No.: US 2007/0283027 A1
(43) Pub. Date: Dec. 6, 2007

(54) SYSTEM AND METHOD FOR PROVIDING QUANTITIES OF DATA FOR A COMMUNICATION

(75) Inventor: Thomas Hoffmann, Landau (DE)

Correspondence Address: DARBY & DARBY P.C., P.O. BOX 770, Church Street Station, New York, NY, 10008-0770, US

(73) Assignee: COMBOTS PRODUCT GMBH, Karlsruhe (DE)

(21) Appl. No.: 11/751,097

(22) Filed: May 21, 2007

(30) Foreign Application Priority Data
May 19, 2006 (DE) 10 2006 023 600.9

(51) Int. Cl. G06F 15/173; G06F 15/16

(52) U.S. Cl. 709/229; 709/225

(57) ABSTRACT

A method for providing a quantity of data for a communication between at least a first user and a second user of a communication system includes granting a first user an access right for using the quantity of data for active use. The quantity of data is also provided to the second user for passive use. An access right for using the quantity of data is granted to the second user when at least a predefinable condition is obtained.

This application claims priority to German Patent Application DE 10 2006 023 600.9, filed May 19, 2006, the contents of which is hereby incorporated by reference as if set forth in its entirety.

The invention relates to a system and method for providing quantities of data for communication. In particular the invention relates to a system and method for synchronizing large quantities of data, such as image data and/or video data, during real-time communication.

### BACKGROUND

Communication systems in which messages are exchanged between the users spontaneously in real time or quasi-real time are known. Examples of these traditional communication systems include classical telephony or video telephony carried out via circuit-switched network systems, such as the Public Switched Telephone Network (PSTN) or an Integrated Services Digital Network (“ISDN”). Other examples of communication systems in packet-switched network systems, such as in the Internet field, include chat and Instant-Messaging.

Increasingly, multimedia communication is being carried out in which voice, tone, music, images, photos, video, text, documents and other useful data are being transmitted in ever-larger quantities of data of a few megabytes and more. This in turn creates problems in real-time communication, as the sent data must arrive isochronically, or at least promptly, for playback on the receiver side. Even if the network systems, or network and/or subscriber connection (such as DSL connections) with large bandwidths (e.g., 1 Mbit/s and higher) are used, it cannot always be guaranteed that a large volume of data or a large quantity of data reaches the receiver in full and in time.

One problem is the overall usage of network capacities, which can lead to a very marked reduction of the effective transmission speed (e.g., 100 kbit/s or less) on the connection in question. This in turn leads to disruptive time delays in communication, which, in particular in audio and video transmissions, is felt to be very disruptive. In applications which support file transfers, so-called “load bars” are displayed which show the receiver the duration or the time response of the data transmission, with the result that he can at least see when the whole of the quantity of data has been received. However, this measure is only a visualization of the problem and does not actually solve it. In particular in the field of real-time communications, such as Instant Messaging, a load bar would not provide any help whatsoever.

### SUMMARY

An embodiment of the present invention provides a system and method for providing a quantity of data for a communication between at least a first user and a second user of a communication system. The first user is granted an access right for using the quantity of data for active use. The quantity of data is also provided to the second user for passive use. An access right for using the quantity of data is granted to the second user when at least a predefinable condition is obtained.

### BRIEF DESCRIPTION OF THE DRAWINGS

Exemplary embodiments of the present invention are explained in more detail below with reference to the accompanying drawings, in which:

FIG. 1 illustrates, schematically, a structure of a communication system and method according to an embodiment of the present invention; and

FIG. 2 illustrates, schematically, a logical network structure for a communication system according to an embodiment of the present invention.

### DETAILED DESCRIPTION

One aspect of an embodiment of the present invention provides a system and method for providing quantities of data for a communication which overcomes the above-named disadvantages in an advantageous manner. In particular, an improved system and method for synchronizing large quantities of data such as image data and/or video data, during a real-time communication is provided.

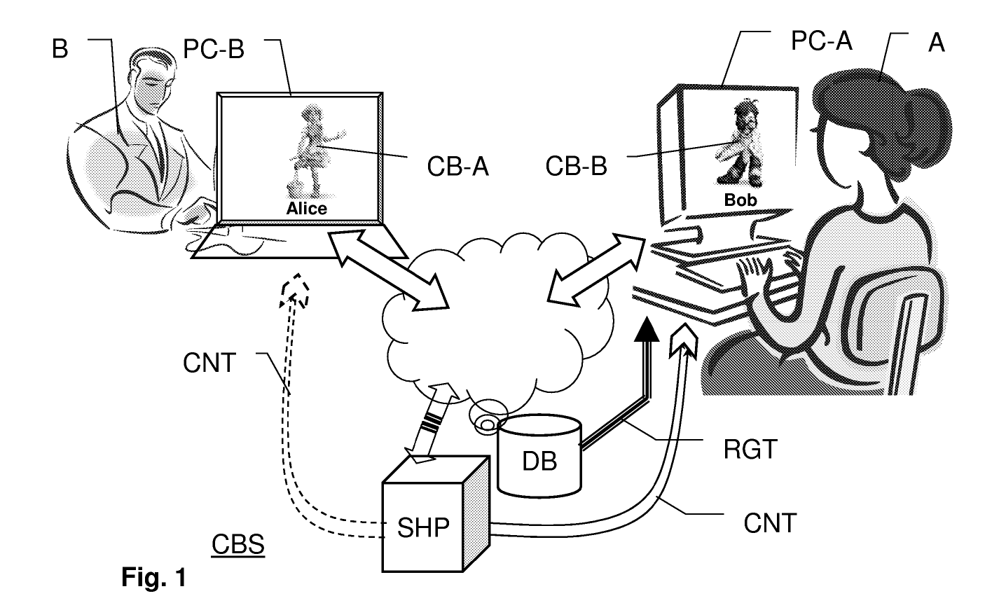

According to a feature of an embodiment of the present invention, as illustrated in FIG. 1, a method is provided for providing quantities of data for a communication between at least two users of a communication system. In the method, a first user A is granted an access right RGT, or right to use, for a quantity of data CNT that can be used for communicating with a second user B. For the first user A, the quantity of data CNT is provided for active use or utilization. For the second user B, the quantity of data is provided only for passive use or utilization, such that the second user B cannot obtain, or be granted, an access right RGT or right to use the quantity of data CNT until predefinable conditions have been met.

In addition, a feature of an embodiment of the present invention provides a communication system which has a first device for communication between terminals of users, as illustrated in FIG. 1. The first device grant access rights for the use of quantities of data by the users. The system also includes a second device SHP connected to the communication system for providing the quantities of data for a communication between the users. The first device grants the first user an access right to use a quantity of data which can be used for a communication with a second user, while the second device actively provides this quantity of data to the first user and passively provides, or keeps ready, this quantity of data for the second user. The first device does not grant the second user an access right to use this quantity of data until predefinable conditions have been obtained.

In an embodiment of the present invention, it is made possible that at the time the rights are granted to the first user, or at least immediately thereafter, the quantity of data is provided not only to this authorized user, who has an active access right or right of use, but also immediately to the second user who does not yet have or need such an access right, but can passively use the quantity of data. In this case, active utilization or use means that the authorized first user can use the whole of the quantity of data. In particular, the authorized first user can start and execute programs or functions which access the quantity of data and/or process the quantity of data. On the other hand, passive utilization essentially means that the unauthorized second user can use the quantity of data only to a predefinable extent. The passive utilization or use is also limited in comparison with the active utilization by and/or depending on regulations, requirements, settings, etc. which the granting of rights specifies.

An embodiment of the present invention is based on the idea that the granting of rights can be managed or controlled separately from the actual data transmission, with the result that the unauthorized user and/or his terminal can also access and use the quantity of data. The present invention can be used advantageously in communication systems in which a rights management is integrated, wherein the user controls the use of or access to the data. For example, the quantity of data can comprise graphic data for an icon, a symbol or a figure such as an animated figure. The first user acquires the icon, the symbol, or the figure in order to use this as a representative or avatar vis-à-vis the second user within the communication. Once the quantity of data is provided for the first user, and regardless of whether the first user is already actually using the quantity of data, the quantity of data is also immediately provided for the second user, without the consent or knowledge of the second user. Thus both users, in particular the second user, already have the quantity of data available to them before it is actually used.

In an embodiment of the present invention, a type of pre-loading of the quantity of data onto the terminals of both users can take place. The granting of rights or rights management preferably relates to data or quantities of data or parts thereof which are provided by the communication system itself or for the communication in the system. Examples of the data include client software, program parts for same (plug-ins), graphic data, in particular figures, animations, sound, etc. The purely private user data, such as private images, photos and/or documents, etc., are not subject to the system's granting of rights, but to that of the respective user, in particular of the owner or originator, of the private data. However, rights management can have a supporting effect here and, depending on the user (e.g., owner, originator) approve and/or limit data access for the other users (e.g., communication partner).

Advantageous possibilities of use for the present invention arise in Internet-supported communication systems which are connected to an online shop, via which the first user acquires the quantity of data (e.g., a figure and/or an animation of same) and the associated access right or right of use. The quantity of data is immediately also made available to the second user, with the result that the quantity of data can be immediately used on his terminal if a use is triggered by the first user (e.g., playing of the animation).

Preferably, only a limited access right to the quantity of data is granted for the second user, with the result that he or his terminal can use the quantity of data exclusively to communicate with the first user. Thus, for example, the second user cannot start the animation on his own.

In an embodiment of the present invention, the method proposed for providing or transmitting quantities of data for a communication between at least two users of a communication system includes granting, for a first user, an access right or an authorization to use a quantity of data. For the first user, the quantity of data is provided in particular in conjunction with, or depending on, the granting of the access right or the authorization. The quantity of data is also provided for the second user, in particular in conjunction with, or depending on, the granting of the access right or the authorization. It is preferably that no access rights or authorization for use of this quantity of data are granted to the second user at least until predefinable conditions, such as, for example, time, access and/or authentication, are obtained.

According to an embodiment of the present invention, at least until predefinable conditions are obtained, the second user can be granted only an access right which is limited exclusively to use of this quantity of data for communication with the first user.

It is advantageous if the quantity of data is, in each case, transmitted to the first terminal and to the second terminal and stored there in each case. It is also preferable that the quantity of data stored on the respective terminal is accessed as required and depending on the access rights granted to the first user. The second user thereby not only remains passive as far as the access possibilities to the quantity of data are concerned, but also dependent on the requirements of the first user. However, the first user retains control of access to “his data”, i.e., to the quantity of data acquired by him.

In an embodiment of the present invention, it is advantageous if the quantity of data CNT comprises at least useful data and/or control data GDT for representing a communication element which is displayed in the form of a graphic symbol, in particular of an animatable symbol, on a display of the second user. It is also preferable that the presentation of the communication element is changed, in particular animated, using the useful data, depending on the requirements, such as commands and/or inputs, of the first user.

In an embodiment of the present invention, it is advantageous if the quantity of data includes at least control data for functions of a communication element which is used on a terminal of the second user for the input and/or output of communication contents. Depending on the requirements of the first user, the functions of the communication element are activated using the control data.

In an embodiment of the present invention, it is possible to change the presentation of an animatable figure that is displayed as communication element on the terminal or desktop of the second user. The communication element displayed on the terminal or desktop of the second user represents the first user. The animatable figure can be changed depending on the requirements of the first user and within the framework of the authorizations or access rights granted to him (e.g., look, appearance, animation, scope of permitted communication functions. etc.). The communication elements appear which appear on the desktop of the respective communication partner and display controllable contact and access points for direct communication with the respective communication partner are referred to hereinafter as a ComBOT™ or ComBOTs™. ComBOT™ and ComBOTs™ are trademarks of ComBOTS Product GmbH.

A ComBOT™ is essentially a controllable and animatable element (e.g., icon, symbol or figure) which appears on the screen of the terminal, in particular on the desktop, of the respective communication partner and via which the contact to the communication partner can be directly created. A first user can, for example, buy or acquire a ComBOT™ in a desired form in an online shop. The first user buys, for example, a ComBOT™ in the form of a dragon, which is to represent him as avatar to the communication partner. The first user obtains a quantity of data which comprises useful and control data, which determines the display of the ComBOT™ (e.g., graphic data incl. animation) and its properties, such as audio data for sound effects, but also includes rights data for controlling access to further contents and/or services.

With the acquisition of the “dragon” ComBOT™ by the first user, the ComBOT™ or the corresponding quantity of data, which in certain circumstances can have a large volume of several megabytes (MB), is also provided to the second user. Because of the preload of the quantity of data, the second user can, however, use this ComBOT™ immediately and, in particular, also play larger animations. The rights of use of the first user thus also determine the scope of the utilization of this ComBOT™for the second user.

In an embodiment of the present invention, it is advantageous if, on the basis of a request by the first user, the quantity of data is transmitted both to the first terminal and also in close succession, in particular simultaneously or synchronously, to the second terminal. The quantity of data is preferably transmitted to the first terminal and at least parts of the quantity of data, in particular useful data or control data contained therein, are also transmitted to the second terminal. In particular, it is advantageous if only parts of the quantity of data which are required for a delay-free real-time communication between the users are transmitted to the second terminal.

The communication system according to an embodiment of the present invention serves to communicate between terminals of users. The system can include a first device for granting access rights for the use of quantities of data by the users, and a second device connected to the communication system for providing the quantities of data for a communication between the users. The first device grants the first user an access right to use a quantity of data which can be used for a communication with a second user, and the second device actively provides this quantity of data to the first user and passively provides or keeps ready this quantity of data for the second user. In addition, the first device does not grant the second user an access right to use this quantity of data at least until predefinable conditions are obtained.

The first device preferably also includes a rights-management system RM, and it is also preferable that the second device includes an online shop. Preferably, the first device, in particular the rights-management system, only grants the second user an access right which is limited exclusively to a use of this quantity of data for communication with the first user when predefinable conditions are obtained.

Also, using the second device, in particular via the online shop, the quantity of data can in each case preferably be transmitted to the first terminal and to the second terminal for storage there. Using the first device, in particular via the rights-management system, the quantity of data stored in the respective terminal is accessed when needed and depending on the access rights granted to the first user.

Shown in FIG. 1 is a network system CBS in the form of an Internet-supported communication system to which terminals for users of the network system CBS can be connected for direct communication between the users or user-processing units such as personal computers, laptops and/or mobile terminals, etc. Moreover, the network system CBS can also be set up to provide central services, in particular data-storage services, and website-hosting services.

By way of example, FIG. 1 shows a first terminal (processing unit) PC-A and a second terminal (processing unit) PC-B, which are connected to each other via the network system CBS. A first user A, here a user called “Alice”, has access to the network system CBS and access to a direct communication with a communication partner via the first terminal PC-A. A second user B, here a user called “Bob”, who is also the communication partner of “Alice”, has access to the network system CBS and access to a direct communication with the communication partner “Alice” via the second terminal PC-B.

The network system CBS makes possible a direct communication, controllable via communication elements CB-A and CB-B, wherein these communication elements are formed as graphic symbols and controllable elements, which are in each case represented on the screen or display of the terminals or processing units. In particular, the communication elements are shown as animatable figures or avatars on the user interface or desktop of the user, and represent, respectively, the other communication partner. These communication elements CB-A and CB-B serve for direct communication and are also called “ComBOTs™”. A ComBOT™ is essentially a controllable and animatable element (e.g., icon, symbol or figure) which, on the screen of the communication partner in question (e.g., user A), represents the contact with the other communication partner (e.g., user B) and via which a communication can be created or carried out directly.

As is shown in FIG. 1, a ComBOT™ CB-A, which represents the other user A, namely here the user “Alice”, is located on the screen of the terminal PC-B of the user B, namely here on the desktop of the user “Bob”. Conversely, there is a ComBOT™ (CB-B) on Alice's screen or desktop. The look and appearance of the respective ComBOT™ can be determined by any user, preferably the user who is represented by the respective ComBOT™. Thus, Alice can determine how her ComBOT™ CB-A is to look on Bob's desktop. Conversely Bob can determine how his ComBOT™ CB-B is to look on Alice's desktop.

It is however also possible, alternatively or additionally, that each user can determine for his screen how the ComBOT™ of the other user is to look. Thus, on his screen, Bob can determine the appearance or the look of the ComBOT™ CB-A which represents Alice. The same applies conversely for Alice, who can determine for her screen or desktop how the ComBOT™ CB-B is to look there. In addition to the look the ComBOTs™ can also be provided with text data, information or pointers, in particular with name details or name badges.

In the example shown here, Alice is represented on the desktop of Bob (user B) by a figure in traditional Alpine costume, a type of girl based on the well-known literary character “Heidi”. Bob is represented on the desktop of Alice (user A) by a figure in street-wear and with a PC keyboard, namely a man intended to represent the character of a “PC freak”.

In the processing units or terminals PC-A and PC-B respectively, a piece of application software, which is preferably client software, is run and which is connected to a central control device within the network system or communication system CBS, in particular to a server installed there. The client software carries out an authentication of the respective user A or B in the communication system. Furthermore, signalling data are exchanged with the help of the client software which is run on the respective terminal PC-A and PC-B, with the result that the central control device controls, or can at least prompt the construction of, various transmission paths within the network CBS and its network nodes for the transmission of the useful data required for communication. The terminals PC-A and PC-B are thus to be seen as end-nodes for the communication. A transparent two-point connection between the end-nodes, called p2p connection (peer-to-peer) for short, can be constructed. Connections via individual or several network nodes, in particular in the form of store & forward connections, can also be made.

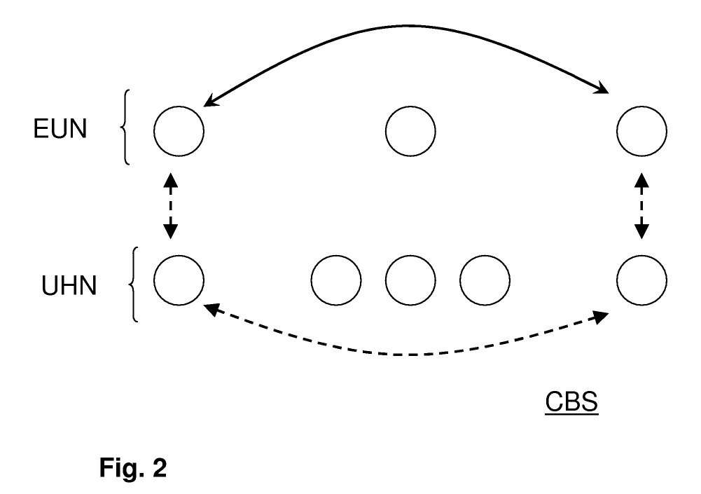

This is also illustrated with the help of FIG. 2, which shows an exemplary specific network structure of the communication system. The network elements embedded in the CBS system are called nodes, wherein the terminals PC-A and PC-B of the users, i.e., the clients or the terminals having the client software running thereon, are called user end-nodes EUN. In addition, the actual network nodes, in particular the servers or the server software running on them, which interchange with the clients, are called user home nodes UHN. A p2p connection is a direct transparent connection between two user end-nodes EUN and is suitable, for example, for a direct data transmission between two users online. A store & forward connection is an indirect connection between two user end-nodes EUN which runs via at least one user home node UHN and is suitable, for example, for a data transmission between two users if the receiving user should be offline.

Returning to FIG. 1, the transmission or provision of data and the rights management for same are now described in more detail:

The procurement of quantities of data, in particular of useful data, can involve the most varied types and/or quantities of data, such as image and/or video data, sound and/or music data. Or, the data can be control data or function data such as animation data and/or sequences for the animation of the image or video data, etc. Whole contact elements (ComBOTs™) can also be included in this, with the result that the user procures or buys for himself a specific ComBOT™ with which he wishes to present himself or the communication partner.

The sequence of a method according to an embodiment of the present invention in the communication system CBS represented in FIG. 1 is as follows:

In the illustrated example, the first user Alice has bought, in the online shop SHP, a ComBOT™ CB-A in the form of the said “Heidi”, with which she wishes to present herself on the desktop or terminal PC-B of Bob (the second user B). This ComBOT™ CB-A is also called “Heidi ComBOT™” for short below. Connected to the graphic representation of the “Heidi ComBOT™” are specific animations and functions which are carried out by the system by or on the basis of communication triggered by Alice. Thus, the “Heidi ComBOT™” can be animated during a transmission to Bob, triggered by Alice, of an MP3 music file, with the result that “Heidi” conjures up an alpenhorn from which notes emanate or musical tones ring out. Bob is thereby immediately made aware of the file transmission prompted by Alice. A relatively elaborate animation can thus be executed which can reinforce the emotion in the communication and thus make possible a non-verbal communication.

Conventional systems, such as chat systems, use formats which can be transmitted quickly, because of their data size, for the exchange of animations. The formats also have an effect on the quality of the animations. The better the image quality and the data contained in the image, the more items of information must be transmitted. This applies in particular to pixel images. However, in conventional systems, no real-time communication is possible even with a correspondingly smaller file size, as the data must always be transmitted promptly and as synchronously as possible during the communication. Further, the communication in conventional systems is not free from gaps in transmission or disruptive pauses, with the result that the receiver frequently obtains disruptive, in particular jerky, image sequences. In order to avoid this, conventional systems use small data formats and very simple animations which use few image frames in order to keep the data size small.

According to an embodiment of the present invention, the data which is necessary for the real-time communication is already synchronized before use for both users of the network. To this end, the system checks, when online, all possible connections to the communication partners for quantities of data, data sets, or files which could be exchanged during a communication as representing emotions. The system performs the synchronization of the data and transmits the necessary data sets or files for the execution time in the background. In other words, all the users' animations, images or sounds are loaded onto the hard drive of the communication partner in order that these can be transmitted in real time when used during a communication. Thus, no time delays result which could block a communication or conversation. In order that the receiving communication partner (here Bob) cannot use these data, as he has not acquired them, a rights management of the system checks their use.

Using the example represented in FIG. 1:

Alice (user A) invites Bob (user B) by, for example, sending an e-mail with a link, to register for a system CBS which makes it possible to talk to her. Within the system CBS there exist different animations which can be sent during a communication or conversation, alongside other data, such as, for example, text messages. In this example, Alice has already been registered for some time on the system CBS and has already bought further animations, e.g. from in the shop SHP, which a new user, such as Bob, does not own.

After first logging onto the system, Bob receives all the animations from the system provided by download which he needs for all possible conversations with Alice. Alice now wishes to send Bob, during a communication or conversation, an animation for which Bob does not own rights to dispatch himself, but which Bob can receive from Alice, as Alice has acquired the rights to these data (e.g., animation data).

In an embodiment of the present invention, this is possible without time delay, as Bob already has the necessary data or files on his hard drive through the synchronization. The rights are administered by the system via a rights-management DB. Thus it is ensured that Bob can use the conversation elements necessary for Alice only after acquiring them himself.

Accordingly, in an embodiment of the present invention, the transmission of animations, images, sounds, etc. for sending emotions in significantly increased quality is possible through the system and method described above. As a result, technical limitations are no longer set by the data size. In particular, the frame rate of animations can be clearly increased. In addition, communication with animations or other data can take place without delays.

While the invention has been particularly shown and described with reference to preferred embodiments thereof, it will be understood by those skilled in the art that various changes in form and details may be made therein without departing from the spirit and scope of the invention.

What is claimed is:

1. A method for providing a quantity of data for a communication between at least a first user and a second user of a communication system, the method comprising the steps of:
granting a first access right to the first user for using the quantity of data;
providing the quantity of data for active use for the first user;
providing the quantity of data for passive use for the second user; and
granting, when at least a predefinable condition is obtained, a second access right to the second user for using the quantity of data.

2. The method as recited in claim 1, wherein the second access right is limited exclusively to use of the quantity of data for communication with the first user, and further comprising the step of:
granting, if a second predefinable condition is obtained, a third access right to the second user for using the quantity of data.

3. The method as recited in claim 1, further comprising the steps of:
transmitting the quantity of data to a first terminal associated with the first user;
storing the quantity of data transmitted to the first terminal in the first terminal;
transmitting the quantity of data to a second terminal associated with the second user;
storing the quantity of data transmitted to the second terminal in the second terminal; and
accessing the quantity of data stored in at least one of the first and second terminals as required and based on the first access right.

4. The method as recited in claim 1, wherein:
the quantity of data comprises at least one of useful data and control data for representing a communication element,
and the method further comprises the steps of:
displaying the communication element to the second user in the form of a graphic symbol on a display; and
changing a representation of the communication element depending on at least one requirement of the first user.

5. The method as recited in claim 4, wherein the communication element is an animatable symbol.

6. The method as recited in claim 4, wherein the at least one requirement of the first user includes at least one of commands and inputs.

7. The method as recited in claim 4, wherein the step of changing a representation of the communication element comprises changing an animation of the communication element.

8. The method as recited in claim 1, wherein the quantity of data comprises control data for functions of a communication element useable on a terminal of the second user for at least one of an input and output of communication contents, and further comprising the step of:
activating a function of the communication element using the control data and depending on a requirement of the first user.

9. The method according to claim 1, further comprising the step of:
transmitting the quantity of data to both a first terminal of the first user and a second terminal of the second user in close succession on the basis of a request by the first user.

10. The method according to claim 9, wherein the quantity of data is transmitted simultaneously or synchronously.

11. The method as recited in claim 1, further comprising the steps of:
transmitting the quantity of data to a first terminal of the first user; and
transmitting a part of the quantity of data to a second terminal of the second user.

12. The method as recited in claim 11, wherein the part of the quantity of data transmitted to the second terminal comprises at least one of useful data and control data.

13. The method as recited in claim 11, wherein the part of the quantity of data transmitted to the second terminal comprises only parts of the quantity of data which are required for a delay-free real-time communication between first and second user.

14. A system for communication between a first user and a second user, the system comprising:
a first terminal associated with the first user;
a second terminal associated with the second user;
a first device operable to issue access rights for a use of a quantity of data for the users; and
a second device operable to provide the quantity of data for the first user for active use or for the second user for passive use,
wherein the first device does not grant an access right for the use of the quantity of data to the second user at least until a predefinable first condition has been obtained.

15. The system as recited in claim 14, wherein:
the first device comprises a rights-management system, and
the second device comprises an online shop.

16. The system recited in claim 14, wherein the access right is limited exclusively to a use of the quantity of data for communication with the first user until at least a predefinable second condition has been obtained.

17. The system as recited in claim 15, wherein the access right is limited exclusively to a use of the quantity of data for communication with the first user until at least a predefinable second condition has been obtained.

18. The system as recited in claim 14, wherein:
the second device is further operable to transmit the quantity of data to the first terminal and to the second terminal for storage; and
the first device is operable to access the quantity of data stored in at least one of the first and second terminals when needed and based on a second access right of the access rights, the second access right being granted to the first user.

19. The system as recited in claim 18, wherein the second device includes an online shop and the first device includes a rights management system.

20. A system for communication between a first user and a second user, the system comprising:
a first terminal associated with the first user;
a second terminal associated with the second user;
a first device operable to issue access rights for a use of a quantity of data for the users; and
a second device operable to provide the quantity of data for the first user for active use, and further operable to provide the quantity of data for the second user for passive use,
wherein the first device does not grant an access right for the use of the quantity of data to the second user at least until a predefinable condition has been obtained.
